(19) United States
(12) Patent Application Publication
(10) Pub. No.: US 2021/0097552 A1
(43) Pub. Date: Apr. 1, 2021

(54) PROACTIVE CUSTOMER CARE-PROFILING WITH MODELING OF EVENT SEQUENCES AND RELATIONSHIPS

(71) Applicant: AT&T Intellectual Property I, L.P., Atlanta, GA (US)

(72) Inventors: Nathaniel Meyer, Plano, TX (US); Kenrick O. Fernandes, Bedminster, NJ (US)

(73) Assignee: AT&T Intellectual Property I, L.P., Atlanta, GA (US)

(21) Appl. No.: 16/589,801

(22) Filed: Oct. 1, 2019

(51) Int. Cl. G06Q 30/00

(52) U.S. Cl. CPC G06Q 30/016; G06N 20/00

(57) ABSTRACT

Aspects of the subject disclosure may include, for example, capturing heterogeneous event data associated with a pool of customers and selecting, based on the heterogenous event data, a set of event labels and a set of customer labels. Some embodiments include constructing, for each of a plurality of customers among the pool of customers, a respective time-ordered event sequence array comprising one or more event information items. Various embodiments include applying a heterogenous event sequence model to generate, based on the respective time-ordered event sequences of the plurality of customers, an ordered series of event pathways and a topic set comprising a plurality of topics representing customer traits. Some embodiments include applying the heterogenous event sequence model to generate a respective topic weight set for each of the plurality of customers. Other embodiments are disclosed.

### FIELD OF THE DISCLOSURE

The subject disclosure relates to a system for proactive customer care-profiling with simultaneous modeling of event sequences and relationships.

### BACKGROUND

The past decade has seen a surge in the apparent popularity of computing-based “intelligence” and “learning” techniques, accompanied by a semantically sparse array of buzzwords. Those desiring to leverage results discovered and evaluated in research settings (whether academic or industrial) often encounter a couple of key challenges: the difficulty (or lack of) reproducibility, and the challenge of translating the scope and meaning of results communicated in technical literature to a broader audience. Vendors often come to the rescue when solutions are needed for specific business processes, but machine learning practitioners discover that the pressures of delivery on a schedule often lead to reliance on the most easily implementable work. The need for digestible storytelling further complicates the data science practitioner's work if the modeling methods do not lend themselves to straightforward interpretation. In addition, more data is often seen as a better situation without additional qualifications.

### BRIEF DESCRIPTION OF THE DRAWINGS

Reference will now be made to the accompanying drawings, which are not necessarily drawn to scale, and wherein:

FIG. 1 depicts a first exemplary plate notation, a second exemplary plate notation, and a third exemplary plate notation.

FIG. 2 depicts a fourth exemplary plate notation and a fifth exemplary plate notation.

FIG. 3 depicts an exemplary system overview diagram.

FIG. 4 depicts an overview of an event representation & storage scheme.

FIG. 5 depicts an overview of an analytics, modeling, and relationship discovery scheme.

FIG. 6 depicts an overview of an insight visualization scheme.

FIG. 7 depicts an overview of a feedback-based updating scheme.

FIG. 8 depicts an illustrative embodiment of a first method.

FIG. 9 depicts an illustrative embodiment of a second method.

FIG. 10 depicts an illustrative embodiment of a third method.

FIG. 11 is a block diagram illustrating an exemplary, non-limiting embodiment of a communications network in accordance with various aspects described herein.

FIG. 12 is a block diagram illustrating an example, non-limiting embodiment of a virtualized communication network in accordance with various aspects described herein.

FIG. 13 is a block diagram of an example, non-limiting embodiment of a computing environment in accordance with various aspects described herein.

FIG. 14 is a block diagram of an example, non-limiting embodiment of a mobile network platform in accordance with various aspects described herein.

FIG. 15 is a block diagram of an example, non-limiting embodiment of a communication device in accordance with various aspects described herein.

### DETAILED DESCRIPTION

The subject disclosure describes, among other things, illustrative embodiments for customer profiling using heterogenous event sequence models. Various embodiments include capturing heterogeneous event data associated with a pool of customers and selecting, based on the heterogenous event data, a set of event labels and a set of customer labels. Some embodiments include constructing, for each of a plurality of customers among the pool of customers, a respective time-ordered event sequence array comprising one or more event information items. Various embodiments include applying a heterogenous event sequence model to generate, based on the respective time-ordered event sequences of the plurality of customers, an ordered series of event pathways and a topic set comprising a plurality of topics representing customer traits. Some embodiments include applying the heterogenous event sequence model to generate a respective topic weight set for each of the plurality of customers. According to various such embodiments, each such topic weight set comprises a corresponding weight for each of the plurality of topics of the topic set. Some embodiments include initiating a customer care action for a customer among the plurality of customers, based on the respective topic weight set for the customer.

One or more aspects of the subject disclosure include a device comprising a processing system including a processor and a memory that stores executable instructions that, when executed by the processing system, facilitate performance of operations. The operations can include capturing heterogeneous event data associated with a pool of customers and selecting, based on the heterogenous event data, a set of event labels and a set of customer labels. The operations can also include constructing, for each of a plurality of customers among the pool of customers, a respective time-ordered event sequence array comprising one or more event information items. The operations can further include applying a heterogenous event sequence model to generate, based on the respective time-ordered event sequences of the plurality of customers, an ordered series of event pathways and a topic set comprising a plurality of topics representing customer traits. The operations can additionally include applying the heterogenous event sequence model to generate a respective topic weight set for each of the plurality of customers. Each topic weight set can comprise a corresponding weight for each of the plurality of topics of the topic set. The operations can further include initiating a customer care action for a customer among the plurality of customers, based on the respective topic weight set for the customer.

One or more aspects of the subject disclosure include a machine-readable storage medium, comprising executable instructions that, when executed by a processing system including a processor, facilitate performance of operations. The operations can include capturing heterogeneous event data associated with a pool of customers and selecting, based on the heterogenous event data, a set of event labels and a set of customer labels. The operations can also include constructing, for each of a plurality of customers among the pool of customers, a respective time-ordered event sequence array comprising one or more event information items. The operations can further include applying a heterogenous event sequence model to generate, based on the respective time-ordered event sequences of the plurality of customers, an ordered series of event pathways and a topic set comprising a plurality of topics representing customer traits. The operations can additionally include applying the heterogenous event sequence model to generate a respective topic weight set for each of the plurality of customers. Each topic weight set can comprise a corresponding weight for each of the plurality of topics of the topic set. The operations can further include initiating a customer care action for a customer among the plurality of customers, based on the respective topic weight set for the customer.

One or more aspects of the subject disclosure include a method. The method can include capturing, by a processing system including a processor, heterogeneous event data associated with a pool of customers and selecting, based on the heterogenous event data, a set of event labels and a set of customer labels. The method can also include constructing, by the processing system, for each of a plurality of customers among the pool of customers, a respective time-ordered event sequence array comprising one or more event information items. The method can further include applying, by the processing system, a heterogenous event sequence model to generate, based on the respective time-ordered event sequences of the plurality of customers, an ordered series of event pathways and a topic set comprising a plurality of topics representing customer traits. The method can additionally include applying, by the processing system, the heterogenous event sequence model to generate a respective topic weight set for each of the plurality of customers. Each topic weight set can comprise a corresponding weight for each of the plurality of topics of the topic set. The method can further include initiating, by the processing system, a customer care action for a customer among the plurality of customers, based on the respective topic weight set for the customer.

The modern customer is subject to the grand designs of enterprises that have become fascinated with experience design in the modern era, as compared to merely product design. Simply putting out a product or service to use is no longer sufficient, and the spread of design thinking for the customer experience is evidence of this. The experience of the customer can be thought of and represented as an ordered sequence of events, with temporal information attached to event occurrence and possibly duration as well. “Event” in this case is the generic archetype for a potentially large number of possible specific instantiations, covering creation or installation, maintenance, customer support and interaction, billing, product/service interaction (such as viewership) and other parts of the customer experience. In the enterprise context, these are usually created and/or logged to a number of different applications/systems, which may not talk to each other.

Dealing with this kind of data, especially at a large scale, brings the usual challenges associated with big data such as storage and processing. However, discovering insights from this kind of data poses some unique challenges. Since events may not be regularly sampled like traditional time series, traditional time series analysis methods may not be applicable or easily adapted. A variety of meanings and attributes are associated with different events, in addition to a temporal ordering, and these additional sources of information must be captured in modeling. Not all the pieces of the puzzle may be observed, or it may be challenging/not possible to incorporate the experience and intuition of subject matter experts (SMEs). Representing and analyzing the customer base as individuals, including the relationships between them (in contexts such as a family plan) as well as the events themselves in the context of the business processes and offerings is necessary in an interpretable manner. In the enterprise context in particular, many sources of data will be noisy and containing errors, which either have to be removed completely prior to data science work, or the method must be able to capture these errors and provide interpretable error bounds on the results. These challenges motivate data scientists and engineers to research, develop and deploy analytics pipelines that can simultaneously work at the scale required, while delivering on the need for insights.

Event data logged in the enterprise context is naturally unlabeled, lending itself to unsupervised machine learning methods. Much data captured in the enterprise context, especially around customers, continues to be analyzed by SMEs and executives in business units. This wealth of experience and insight is often used to guide the process of data science inquiries, but not during model building. By using latent or unobserved variable models, one or more of the exemplary embodiments can capture this information in the modeling process. Latent variable models essentially posit that there is an underlying structure to the observed data, the structure of which can be modeled in the abstract and then specific values learned using machine learning methods. This provides increased flexibility and power in modeling and lends itself well to providing an accurate and detailed description as the data-generating process and the subsequent insights from the analysis can be represented in terms of interpretable, known variables/factors that can capture valuable human knowledge and experience. The benefits of these models come at an increased computational cost however, with the caveat that the parameters for these models cannot be computed exactly in a reasonable time in the general case. Hence, approximations to the answer can be computed (explained in more detail below) which are usually good enough except in pathological cases.

Mixed-membership models are a group of latent variable models that assume a grouped structure for the observed data. At a high level, they allow for a fixed number of components to exist (which are learned), and they posit that each of the observed data groups (groups as defined in the model) are formed by a combination of each component. This is a natural fit for customer journeys, where each individual event is a data point, and they can be grouped together per customer. Based on intuition and experience, there can be different ways to categorize customers (e.g. at which stage of the life-cycle they are) which fit as components. Two kinds of insights can then be discovered: how each customer can be allocated different percentages of each component, and which events are associated with each component.

When applied to text data, with documents consisting of words from a fixed vocabulary, these components can be thought of as topics for the documents. Each component of topic can be associated with a probabilistic distribution over the words in the vocabulary as well. Structured text data was one of the original use cases (another being genetics and population structure) for the development of these methods. It is helpful to think of our methods then as creating and analyzing a “language” to describe customer journeys.

An overview treatment of unsupervised mixed-membership models for text data can be found in “Probabilistic Topic Models”, Blei, D. M., Communications of the ACM 55, 4 (2012), 77-84. “Latent Dirichlet Allocation”, Blei, D. M., Ng, A. Y., and Jordan, M. I., Journal of Machine Learning Research 3, January (2003), 993-1022 proposes Latent Dirichlet Allocation (LDA) topic models, involving application of hierarchical Bayesian models, a class of directed graphical models, to text data. Parameters are provided for document proportions and topic distributions while treating each document as a simple “bag-of-words.” LDA models such as those discussed in “Latent Dirichlet Allocation” do not account for sequence information available in the words of a document, and some works have attempted to address this issue. “Topic Modeling: Beyond Bag-of-Words”, Wallach, H. M., Proceedings of the 23rd International Conference on Machine Learning (2006), ACM, pp. 977-984 proposes a model which incorporates bigram-level information. “Probabilistic Topic Models for Sequence Data”, Barbieri, N., Manco, G., Ritacco, E., Carnuccio, M., and Bevacqua, A., Machine Learning 93, 1 (2013), 5-29 proposes models that incorporate additional Markovian assumptions such as a topic depending on the previous topic (topic bigram), and a word depending on the previous topic (token bitopic). They apply their approaches to viewership data as well. However, these works do not account for dependence of a word and/or topic on additional previous words and/or topics, which is common in journey datasets created by multiple systems which trigger events simultaneously. Some events/words will have meaningful sequential information while others will not, and this separation is not acknowledged in the model structure proposed in these works. They also do not account for temporal information such as timestamps that can be associated with events, as such information does not occur in text data.

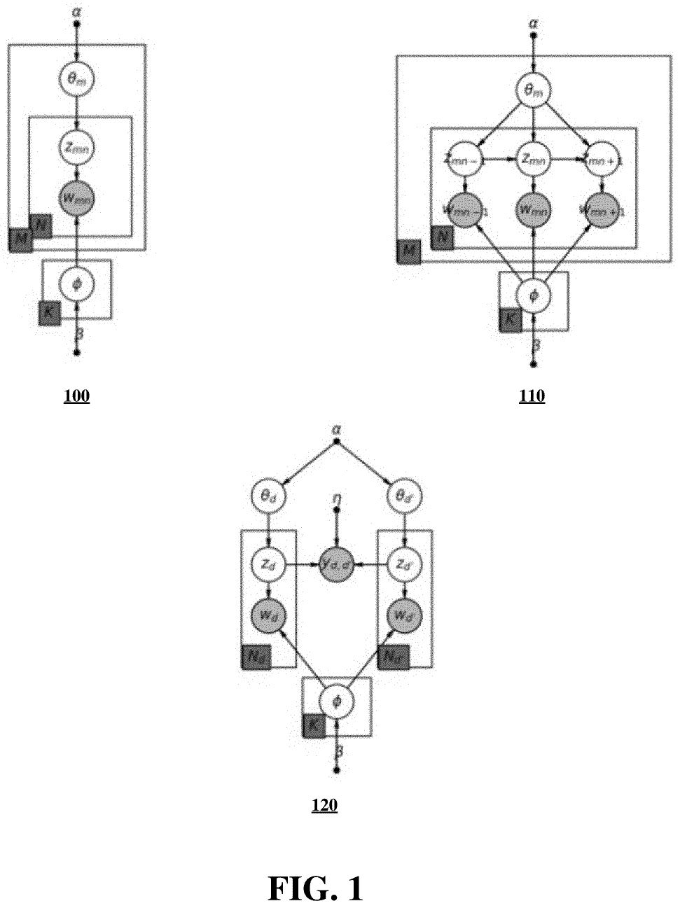

FIG. 1 depicts example plate notation for models of various types discussed above. Plate notation 100 is an exemplary representation of an LDA model. Plate 100 depicts a simple mixed membership model with independence among event-trait associations. This is functionally equivalent to the “bag of words” topic modeling technique applied to a vocabulary of events instead of words. This model is suitable for deriving traits from customer journeys which are not dependent on event sequence.

Plate notation 110 is an exemplary representation of a sequential (topic-bigram) model. Plate 110 depicts a mixed membership model with sequential influence among event-trait associations. Complexity is increased with the benefit of allowing the prior event-trait association to inform the next event-trait association. This model is suitable for deriving traits from customer journeys which exhibit sequential dependency.

Plate notation 120 is an exemplary representation of a relational topic model. Plate 120 depicts the insertion of relational influence among customer journeys. In this figure, a new model variable is introduced for relationships among customers where their journey traits may be influenced by or held constant by an external relation. These relationships may be identity, as in the ‘sameCustomer’ relationship applied to two account journeys, or they may be localized as the ‘sameAddress’ or ‘sameBuilding’ relationships applied to two lines of service. They may also be as abstract as shared influence from a common factor as in ‘sameColor’ or the more descriptive ‘color:Red’. This model variant is suitable for deriving traits from customer journeys where common characteristics of or relationships between journeys are believed to play an influential role.

To deal with temporal information associated with events, some works have explored topic models for sequences of events rather than words. “Topics Over Time: A Non-Markov Continuous-Time Model of Topical Trends”, Wang, X., and McCallum, A., Proceedings of the 12th ACM SIGKDD International Conference on Knowledge Discovery and Data Mining (2006), ACM, pp. 424-433 and “Topic Modeling for Sequences of Temporal Activities”, Shen, Z., Luo, P., Xiong, Y., Sun, J., and Shen, Y., Proceedings of the Ninth IEEE International Conference on Data Mining (2009), IEEE, pp. 980-985 incorporate information about transitions between topics by associating each topic with a distribution over time. The latter also adapts the model to generate timestamps for each event. The evaluation of the models using temporal information in this work is highly limited, and it is also not completely clear exactly how the model process works, in part because no graphical model notation is provided. “Discovery of Activity Patterns Using Topic Models”, Huynh, T., Fritz, M., and Schiele, B., Proceedings of the 10th International Conference on Ubiquitous Computing (2008), ACM, pp. 10-19 uses topic models to discover and label event patterns of users' daily routines.

An issue with the various aforementioned proposals is that they do not consider unique features of the data distributions to refine the models. In addition, these works do not consider relations between the group/documents and how that might affect the topics. An approach discussed in “Hierarchical Relational Models for Document Networks”, Chang, J., Blei, D. M., et al., Annals of Applied Statistics 4, 1 (2010), 124-150 incorporates the effects of network structures between documents into a model. However, it does not consider sequences of events along with temporal information and associated dependencies, nor can it account for attribute information associated with documents.

Disclosed herein are modeling techniques that address various shortcomings of the aforementioned approaches. According to various techniques disclosed herein, a modeling scheme can be implemented that uses heterogenous data from multiple data sources to construct integrated event sequences representing context journeys relating to one or more contexts. Any given one of such contexts may generally constitute a keyed set of context instances, comprising instances/elements of some like type. Each context instance of a given context may be identified by a unique respective context key. An event sequence for a given context instance may generally comprise a time-ordered series of event labels corresponding to observed events associated with that context instance. For a given context, a set of traits may be designated for use as criteria for differentiating treatment among context instances. The set of traits may be identified based on the observed events associated with the various instances of that context. A given context instance may be evaluated/measured based on each of a designated set of traits in conjunction with determination of an action to be taken with respect to that context instance.

In some embodiments, the proposed modeling scheme can be implemented in support of customer care profiling. According to such implementations, the subject context may be a set of customers, and event sequences may be constructed that represent customer journeys associated with those customers. The context keys may, for example, take the form of customer identifiers associated with the customers in the customer set. A customer care action to be taken for a given customer may be determined based in whole or part on evaluation of that customer with respect to each of a designated set of traits. The embodiments are not limited to this example.

In various embodiments, the proposed modeling scheme can represent customer journeys as lists of temporally ordered tuples. Each such list can be associated with a particular customer number, and each such tuple can be associated with a particular event. In various embodiments, a given tuple can include an event label that generally describes the event associated with the tuple. In some embodiments, a given tuple can include an event timestamp that generally describes the timing of the event associated with the tuple. In various embodiments, a given tuple can include a key-value store or other information element indicating attributes associated with the event.

In some embodiments, according to one aspect of the proposed modeling scheme, temporal information can be introduced at the level of events/single tokens. Note that this is different from a change in a topic over time, where the word distribution associated with a topic changes. Here it is desirable to capture the temporal gaps between events, such that the starting point in time of the journey does not matter, only the progression. This uses both a notion of temporal gap as well as that of event context. This can be achieved by recording timestamp information associated with events, then inserting between the events in the journey a token representing the discretized gap between events. Depending on the downstream analysis requirements, the gap can be discretized into small or large intervals, as long as the number of additional tokens is not too large and each token is meaningful to the analysis. With an enhanced vocabulary and journey/document dataset, sequential topic modeling can then be run on this data to associate temporal gaps with events.

Besides the simplicity and scalability of this method for including relative temporal information, the method can easily be adapted to capture the notion of partial position independence. For example, those events which occur simultaneously or are temporally near due to their relationship in logging systems. By sorting all the events occurring during a certain discrete time period according to a pre-defined ordering such as alphabetical and leveraging the results of an event gap analysis, a determination can be made of when it is necessary to include the temporal information tokens. Hence it need only be included where the temporal information is of value to the subset of events occurring after another gap.

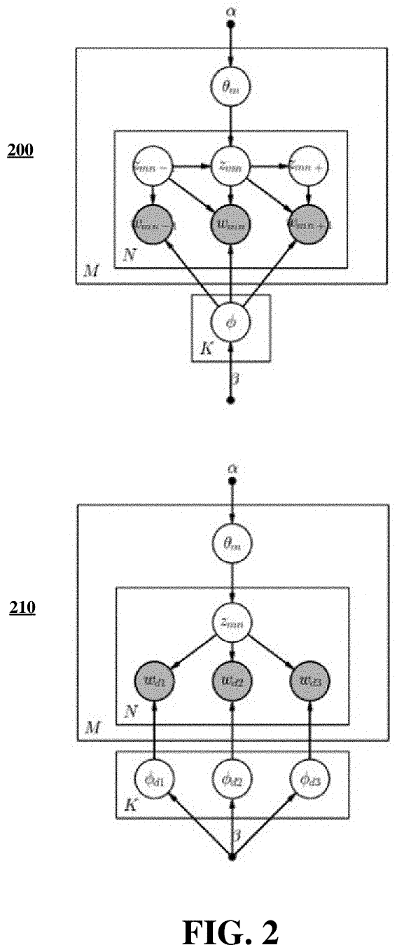

In various embodiments, according to another aspect of the proposed modeling scheme, higher-order dependencies can be captured, such as pathways between event tokens. For example, independent of the associated timestamp, a customer might seek a credit after a poorly-rated interaction. The gap and presence of tokens between these two events might vary, but intuitively it may be expected that these customers display similar proportions of a topic related to credit/support-neediness. In this case, it may be desirable that the current token to be independent of the previous tokens, but be dependent on the current and previous topics. FIG. 2 depicts example plate notation 200 representing a graphical dependency structure that can be representative of such a model. Plate 200 depicts a mixed membership model with sequential influence among event-trait associations and from prior trait to subsequent event. This builds on the model of FIG. 1 plate 110 by adding influence from the prior event-trait to the subsequent event. This model is suitable for deriving traits from customer journeys with sequential event-trait association dependency and a delayed effect from prior trait onto the next event.]

In some embodiments, according to another aspect of the proposed modeling scheme, relational modeling can be adapted to incorporate known information and constraints in real-world data analysis. Relational links are typically treated as symmetric and bi-directional (undirected), when they tend to be asymmetric or uni-directional (directed) in real-world relationships, e.g. a parent purchasing a family plan and devices has more influence over the other members that they have on the parent. In addition, the strength of the link is a simple means of incorporating information about entities and groups involved, such as attributes about location, marketing segment, etc.

In various embodiments, relational information can be incorporated via token inclusion. Adapting tokens with (discretized) relationship information, an extension of the method covered above can provide a simple and scalable means of incorporating relational information. In some embodiments, relational information can be incorporated via hyperparameter sharing. Based on the links between the journeys, there can be incorporated additional constraints that hyperparameters be shared between data samples. For example, if a link in the knowledge base indicates a strong directed relationship between entities A and B, the model can be adapted to indicate that their topic proportion parameters be shared, effectively reducing the parameter space using prior knowledge, which can be seen as regularization. In various embodiments, finer-grained models can be designed for relationships between events rather than topics. For example, customers may visit retail or pop-up store locations regularly, and this may come from a topic component that indicates regular interactions. However, their decision to try a new plan may be dependent on a social “critical mass”, such as a group of friends coming together to the store.

In some embodiments, according to another aspect of the proposed modeling scheme, there can be heterogeneous attributes associated with events. Rather than individual unit tokens, some or all of the data pool can consist of multi-dimensional tokens with heterogenous attributes. The assumption that individual events/tokens are part of a fixed vocabulary can be reused and extended in additional dimensions such that it is assumed that the number of attributes D associated with a particular event/token is fixed. Proceeding from this assumption, a heterogenous attribute LDA model can be defined with the generative process described in Table 1 as follows:

TABLE 1
For each customer/journey c ∈ C (the set of customers/journeys), sample
mixture proportions θ_{c} ~ Dirichlet(a)
Sample φₜ ~ Dirichlet(β) for each of the token dimensions d ∈ {1, . . . ,
D}, for each topic t ∈ {1, . . . , K}
For each event/token in the journey, e ∈ {1, . . . , N_{c}}

Sample topic for the event, z ~ Discrete(θ_{c})
Sample token attributes in each dimension, e ~ Discrete(φ^{d})

FIG. 2 depicts example plate notation 210 representing a graphical dependency structure that can be representative of such a model. Plate 210 depicts a mixed membership model with attributes associated to events. In this diagram, event-trait associations are still one to one with the event but the event placeholders and event-trait priors Phi are now exploded along the attribute dimension D. This model is suitable for deriving traits from customer journeys where events can be decomposed into independent attributes.

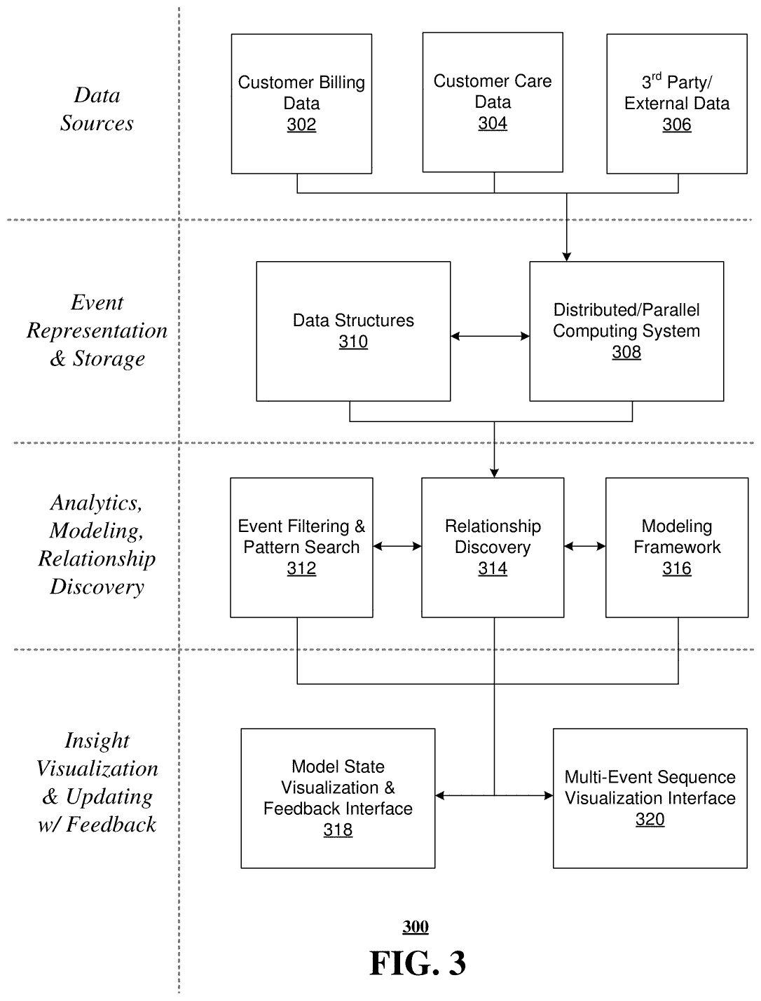

FIG. 3 illustrates a system overview diagram 300 that can be representative of the implementation of the proposed modeling scheme according to various embodiments. System overview diagram 300 depicts various example data sources that can contribute to a heterogenous data pool that is used to implement the disclosed techniques according to some embodiments. System overview diagram 300 also depicts various aspects of event representation and storage, analytics, modeling, relationship discovery, insight visualization, and feedback-based updating.

The data sources depicted in system overview diagram 300 include customer billing data 302, customer care data 304, and third party/external data 306. Customer billing data 302 can include, for example, data relating to customer debits, credits, adjustments, promos, and offers. Customer care data 304 can include, for example, data relating to customer service calls, chats, truck dispatches, and other customer service-related interactions. Third party/external data 306 can include, for example, data relating to customer properties, demographics, mobility, and relationships.

Various types of data such as the aforementioned can generally be handled by a distributed/parallel computing system 308. In various embodiments, distributed/parallel computing system 308 can be used to read, process, and transform such data in conjunction with the implementation of the proposed modeling scheme. In some embodiments, distributed/parallel computing system 308 can feature data backup/redundancy capabilities.

Data structures 310 can be defined and utilized for storage of event information. In various embodiments, data structures 310 can be utilized for offline and/or in-memory storage of essential event information with heterogenous attributes. In some embodiments, event information stored in data structures 310 can include event labels, event descriptions, event-related factors, event metadata, and/or event lineages.

In various embodiments, distributed/parallel computing system 308 and data structures 310 can be leveraged in order to perform event filtering and pattern searching 312. In some embodiments, event filtering and pattern searching 312 can include signal detection for targets. In various embodiments, distributed/parallel computing system 308 and data structures 310 can be leveraged in order to perform relationship discovery 314. In some embodiments, relationship discovery 314 can be conducted using mixture models enabling search of profiles/representations using available big data, for predicting customer actions and segmenting customers. In various embodiments, mixture models employed for relationship discovery 314 can be constructed according to a modeling framework 316. In some embodiments, modeling framework 316 can specify an initial set of Bayesian models incorporating sequence information and temporal information. In various embodiments, modeling framework 316 can define a simple system for tailoring and updating modeling as appropriate for specific cases.

In some embodiments, a model state visualization and feedback interface 318 can enable visual examinations of model states and predictions. In various embodiments, model state visualization and feedback interface 318 can enable the provision of SME feedback and/or individual/institutional knowledge for use to enhance and/or correct model predictions. In some embodiments, a multi-event sequence visualization interface 320 can enable visualization of multi-event sequences locally and globally. In various embodiments, multi-event sequence visualization interface 320 can provide capabilities for monitoring overall customer base behavior. In some embodiments, multi-event sequence visualization interface 320 can also enable monitoring of patterns of individual customers.

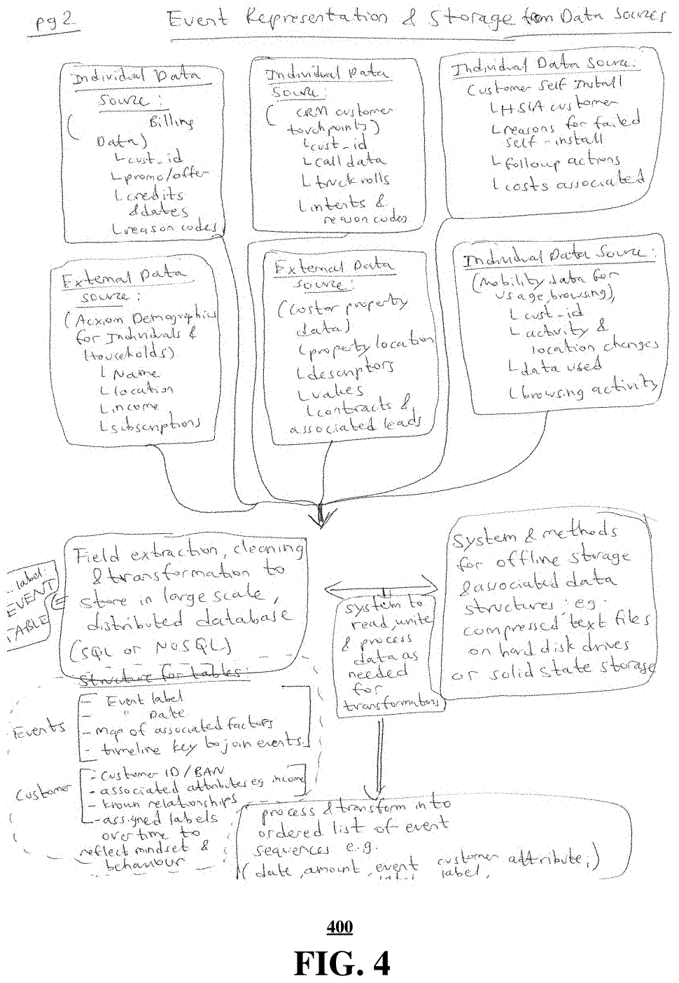

FIG. 4 illustrates an overview 400 of an event representation and storage scheme that can be representative of the implementation of the proposed modeling scheme according to various embodiments. As reflected in overview 400, the event representation and storage scheme makes use of various types of input data, including individual data and external data. In the particular example depicted in overview 400, the utilized input data includes billing data, customer relationship management (CRM) customer touchpoint data, customer self-install data, demographics data for individuals and households, property data, and mobility data. Collectively, these various types of data constitute a heterogenous data pool, as the included parameters differ from data type to data type. Some parameters are common to more than one data type. For example, the “cust_id” parameter is present in the billing data, the CRM customer touchpoint data, and the mobility data. Other parameters are unique to a particular data type. For example, the “promo/offer” parameter is present only in the billing data. The embodiments are not limited to this example.

A computing system, such as distributed/parallel computing system 308 of FIG. 3, may read, write, and process the input data as needed in order to implement various aspects of the event representation and storage scheme. In some embodiments, the system can process and/or transform the data to obtain an ordered list of event sequences. In various embodiments, each entry in the list can include a respective date, amount, event label, and customer label. In some embodiments, any given entry can additionally include one or more attributes.

In various embodiments, via field extraction, cleaning, and transformation of the input data, an event table and a customer table can be constructed. In some embodiments, the event table and/or the customer table can be stored in a large scale distributed database, such as a structured query language (SQL) or non-SQL/NoSQL database. In various embodiments, each entry in the event table can include an event label, an event data, a map of associated factors, and a timeline key. In some embodiments, the timeline key of a given event can aid a determination of whether to join that event with another event. In various embodiments, each entry in the customer table can include a customer identifier (ID)/billing account number (BAN), associated attributes for the customer, known relationships of the customer, and assigned labels associated with the customer. In some embodiments, the assigned labels can comprise labels assigned to the customer over time to reflect the customer's mindset and behavior. In various embodiments, the input data, ordered list of event sequences, event table, and/or customer table can be stored offline. In some embodiments, for example, compressed text files containing these various types of information can be stored on hard disk drives and/or solid state storage devices.

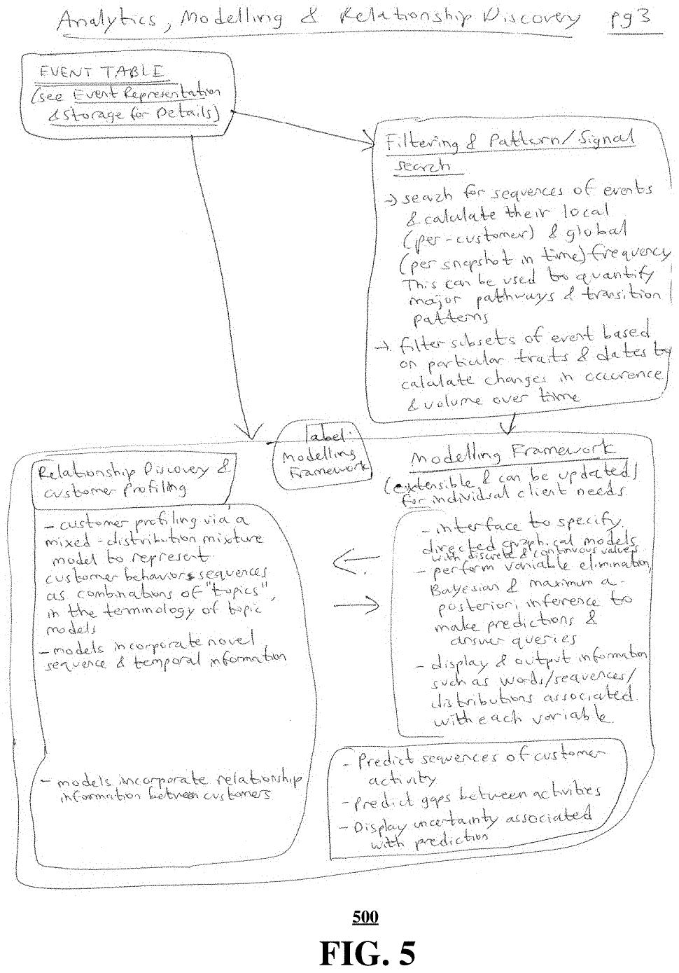

FIG. 5 illustrates an overview 500 of an analytics, modeling, and relationship discovery scheme that can be representative of the implementation of the proposed modeling scheme according to various embodiments. As reflected in overview 500, the analytics, modeling, and relationship discovery scheme can leverage the event table constructed in conjunction with the event representation and storage scheme of FIG. 4. For example, according to the analytics, modeling, and relationship discovery scheme depicted in FIG. 5, filtering and pattern/signal search operations can be conducted on the event table of FIG. 4.

In some embodiments, sequences of events can be identified via the aforementioned pattern/signal search operations. In various embodiments, frequencies of those sequences of events can be determined. In some embodiments, for a given sequence of events, a local (per-customer) frequency can be determined. In various embodiments, a global (per snapshot in time) frequency can additionally or alternatively be determined for the given sequence of events. In some embodiments, determination of such event sequence frequencies can enable quantification of major pathways and transition patterns. In various embodiments, the aforementioned filtering operations can involve filtering subsets of events based on particular traits and dates. In some embodiments, such filtering can be conducted in order to calculate changes in occurrence and volume over time.

In various embodiments, the product/results of filtering and pattern/signal search operations can be used to support features of a modeling framework. In some embodiments, the modeling framework can be extensible, and may be designed such that it can be updated to accommodate individual client needs. In various embodiments, the modeling framework can feature an interface via which a user can specify directed graphical models with discrete and continuous values. In some embodiments, the modeling framework can implement procedures according to which variable elimination and Bayesian and maximum a-posteriori inference are performed in order to make predictions and answer queries. In various embodiments, the modeling framework can be designed to display and output information such as words, sequences, and distributions associated with each variable.

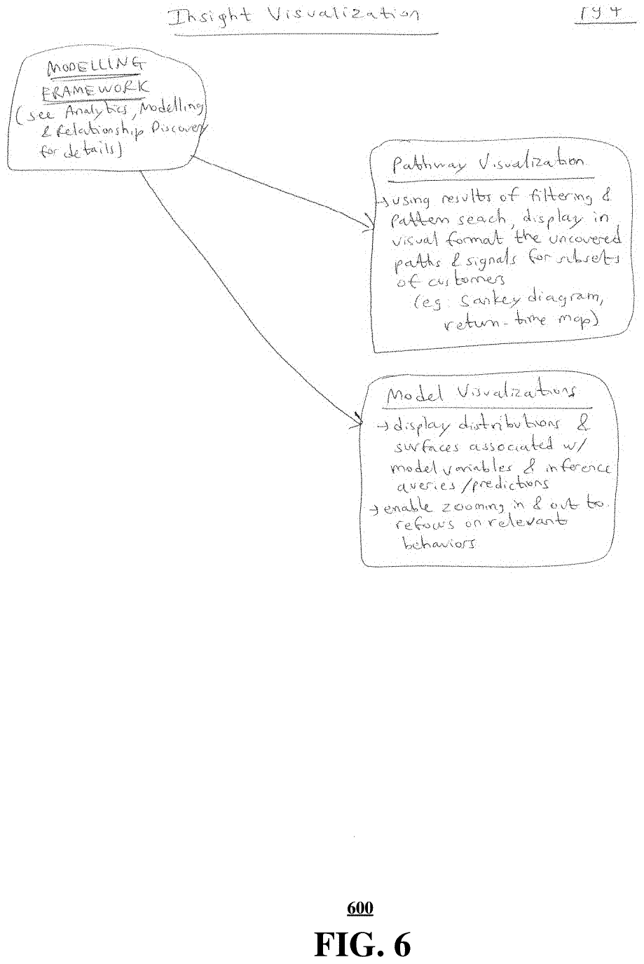

In some embodiments, the modeling framework can support relationship discovery and customer profiling operations. In various embodiments, the modeling framework can implement customer profiling via a mixed-distribution mixture model to represent customer behavior sequences as combinations of topics in the terminology of topic models. In some embodiments, the modeling framework can incorporate novel sequence and temporal information. The conditional probabilities in FIG. 6 overview 500 lists exemplary types of sequential and temporal dependencies that may be incorporated in this modeling framework. The next event-trait association in a sequence may be influenced by the prior two topics. The next event in a sequence may be influenced by the prior two topics in the sequence. The next temporal gap interval between events in a sequence may be influenced by the last two topics-word associations or last two words. Many combinations of types of sequential influence and temporal gaps can be incorporated into the modeling framework. In various embodiments, the modeling framework can incorporate relationship information between customers. The conditional probabilities in FIG. 5 overview 500 lists exemplary types of relational dependencies that may be incorporated in this modeling framework. The next event in a sequence may be influenced by the relationship between this context journey and other context journeys. The next trait-event association in the sequence may be influenced by a relationship between this context journey and another context journey. In some embodiments, the modeling framework can be used to predict sequences of events corresponding to customer activities. In various embodiments, the modeling framework can be used to predict gaps between such events. In some embodiments, the modeling framework can be used to display the uncertainty associated with a given prediction.

FIG. 6 illustrates an overview 600 of an insight visualization scheme that can be representative of the implementation of the proposed modeling scheme according to various embodiments. As reflected in overview 600, the insight visualization scheme can leverage the modeling framework of FIG. 5. The insight visualization scheme depicted in overview 600 can support both pathway visualization and model visualization. In some embodiments, the pathway visualization can use results of filtering and pattern search operations to display uncovered paths and signals for subsets of customers in visual format. For example, in various embodiments, the pathway visualization can be implemented using Sankey diagrams and/or return-time maps. In some embodiments, the model visualization can display distributions and surfaces associated with model variables and inference queries/predictions. In various embodiments, the model visualization can enable zooming in and out to refocus on relevant behaviors.

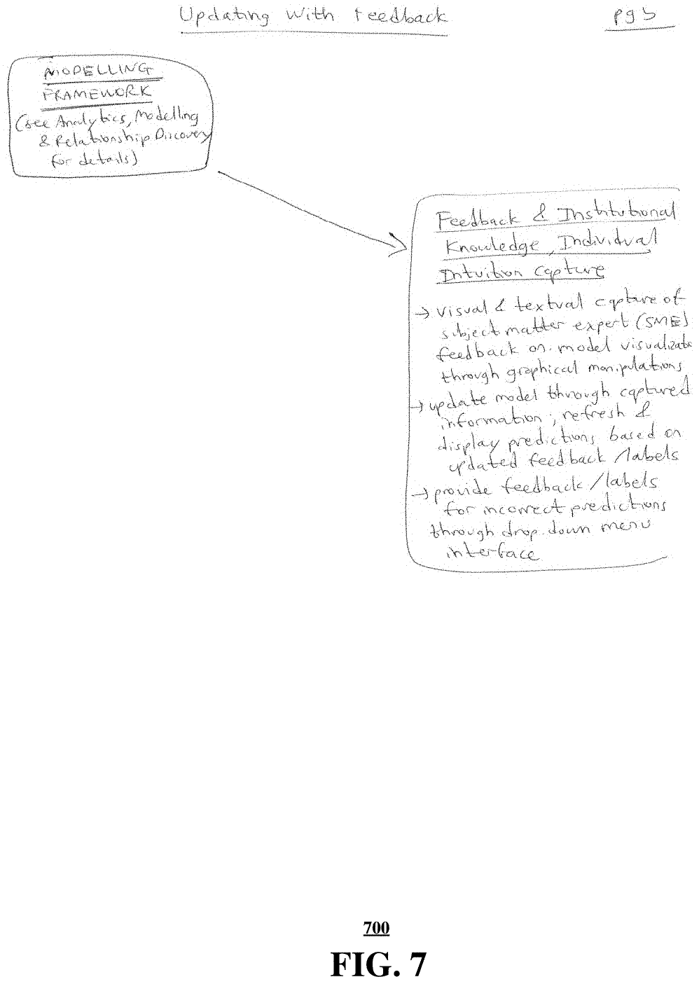

FIG. 7 illustrates an overview 700 of a feedback-based updating scheme that can be representative of the implementation of the proposed modeling scheme according to some embodiments. As reflected in overview 700, the feedback-based updating scheme can leverage the modeling framework of FIG. 5. The feedback-based updating scheme depicted in overview 700 can generally support capture of feedback, institutional knowledge, and individual intuition. In various embodiments, the feedback-based updating scheme can provide for visual and/or textual capture of subject matter expert feedback on model visualizations, through graphical manipulations. In some embodiments, according to the feedback-based updating scheme, a model can be updated through captured information, and predictions can be refreshed and displayed based on updated feedback and/or labels. In various embodiments, feedback and/or labels for incorrect predictions can be provided through a drop-down menu interface of the feedback-based updating scheme.

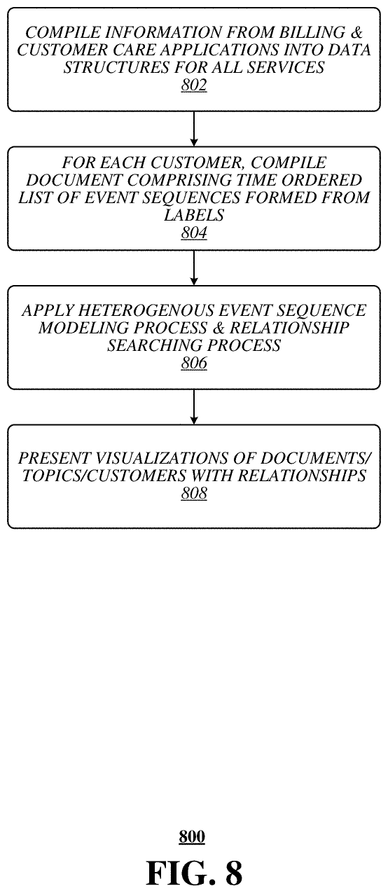

FIG. 8 depicts an illustrative embodiment of a method 800 in accordance with various aspects described herein. While for purposes of simplicity of explanation, the respective processes are shown and described as a series of blocks in FIG. 8, it is to be understood and appreciated that the claimed subject matter is not limited by the order of the blocks, as some blocks can occur in different orders and/or concurrently with other blocks from what is depicted and described herein. Moreover, not all illustrated blocks may be required to implement the methods described herein.

As shown in FIG. 8, information from billing and customer care applications can compiled into data structures for all services at 802. At 804, for each customer, a document comprising a time-ordered list of event sequences can be formed from labels designated for use in conjunction with the data structures defined at 802. At 806, a heterogenous event sequence modeling process and a relationship searching process can be applied to the data produced at 802 and 804. In conjunction with application of these processes at 806, a topic set can be defined. Each topic in the topic set can represent a customer trait learned from the data produced at 802 and 804. In conjunction with application of the processes at 806, a respective topic weight set can be defined for each of a plurality of customers. Each such topic weight set can generally represent a customer as a weighted combination of topics, and can comprise a respective corresponding weight for each of the topics in the topic set.

At 808, visualizations can be presented of documents, topics, and/or customers with associated relationships. For example, a visualization of a customer document can illustrate the relative timings of events associated with that customer, and provide an indication of whether the pace of such events is slowing or quickening. In another example, a visualization of a topic can illustrate the extent to which various labels can be expected to be associated with higher weighting of that topic. In another example, a visualization of a customer can illustrate the respective weightings of each of a plurality of topics according to the topic weight set for that customer.

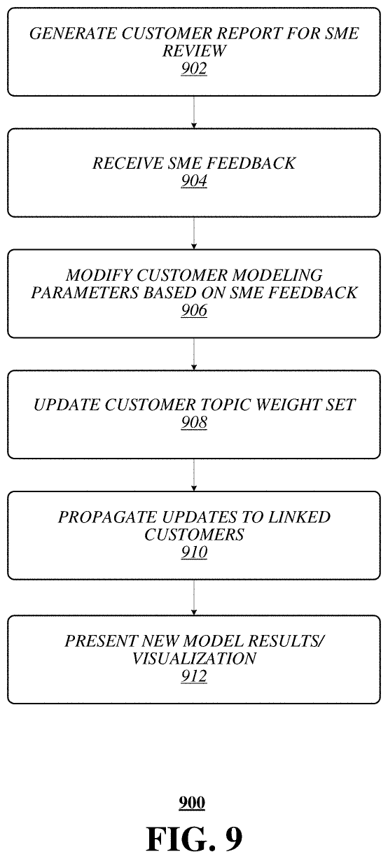

FIG. 9 depicts an illustrative embodiment of a method 900 in accordance with various aspects described herein. While for purposes of simplicity of explanation, the respective processes are shown and described as a series of blocks in FIG. 9, it is to be understood and appreciated that the claimed subject matter is not limited by the order of the blocks, as some blocks can occur in different orders and/or concurrently with other blocks from what is depicted and described herein. Moreover, not all illustrated blocks may be required to implement the methods described herein.

As shown in FIG. 9, a customer report can be generated for subject matter expert review at 902. At 904, subject matter expert feedback can be received for the customer report. At 906, customer modeling parameter(s) can be modified based on the subject matter expert feedback. At 908, the topic weight set of the customer associated with the customer report generated at 902 can be updated. At 910, updates can be propagated to the topic weight sets of linked customers. At 912, new model results and/or new visualizations can be presented based on the modified customer modeling parameter(s) of 906.

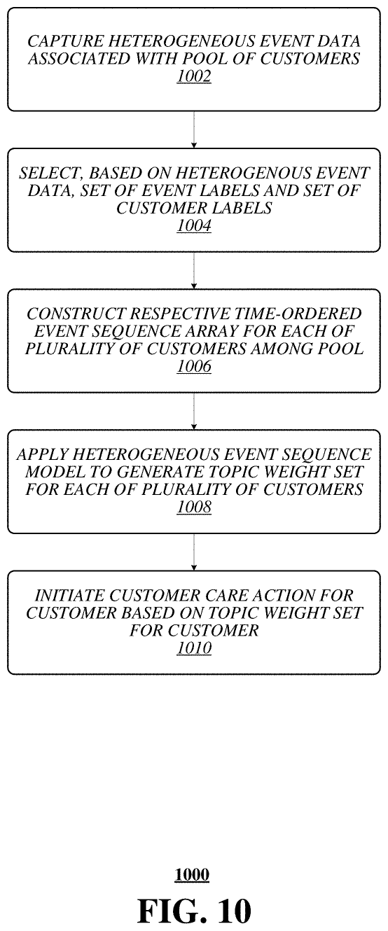

FIG. 10 depicts an illustrative embodiment of a method 1000 in accordance with various aspects described herein. While for purposes of simplicity of explanation, the respective processes are shown and described as a series of blocks in FIG. 10, it is to be understood and appreciated that the claimed subject matter is not limited by the order of the blocks, as some blocks can occur in different orders and/or concurrently with other blocks from what is depicted and described herein. Moreover, not all illustrated blocks may be required to implement the methods described herein.

As shown in FIG. 10, heterogenous event data associated with a pool of customers can be captured at 1002. At 1004, a set of event labels and a set of customer labels can be selected based on the heterogeneous event data captured at 1002. At 1006, a respective time-ordered event sequence array can be constructed for each of a plurality of customers among the pool of customers. At 1008, a heterogeneous event sequence model can be applied to generate a respective topic weight set for each of the plurality of customers. At 1010, a customer care action can be initiated for a customer among the plurality of customers, based on the topic weight set for that customer.

In an example embodiment, a customer care action initiated at 1010 may involve routing a customer call to a particular call center, skill or agent. In a second example, a customer care action initiated at 1010 may involve leading with a specific offer in customer retention/save calls. In a third example, a customer care action initiated at 1010 may involve selecting a particular script or workflow to follow when in technical care interactions. In a fourth example, a customer care action initiated at 1010 may involve selecting a set of relevant articles to display on a web page. In a fifth example, a customer care action initiated at 1010 may involve selecting a particular graphic to display on a web page. A customer care action initiated at 1010 may alternatively or additionally other treatment differentiation in customer care interactions in some embodiments, and the embodiments are not limited to these examples.

The preceding disclosure largely focuses on embodiments involving the implementation of the disclosed modeling techniques in conjunction with customer care profiling, such that customers constitute the context instances with which the constructed event sequences are associated. However, customers are just one example of numerous possible types of contexts for which context journeys may be modeled according to the disclosed techniques. Additional examples of types of contexts for which the disclosed modeling techniques may be implemented include products, locations, households, wireless devices, and cellular network infrastructure elements. The embodiments are not limited to these examples. The actions determined based on traits associated with such other types of contexts in some embodiments may include, for example, product purchasing and distribution decisions, business location marketing directions, cellular infrastructure configuration and maintenance operations, and other trait-based differentiation decisions. The embodiments are not limited to these examples.

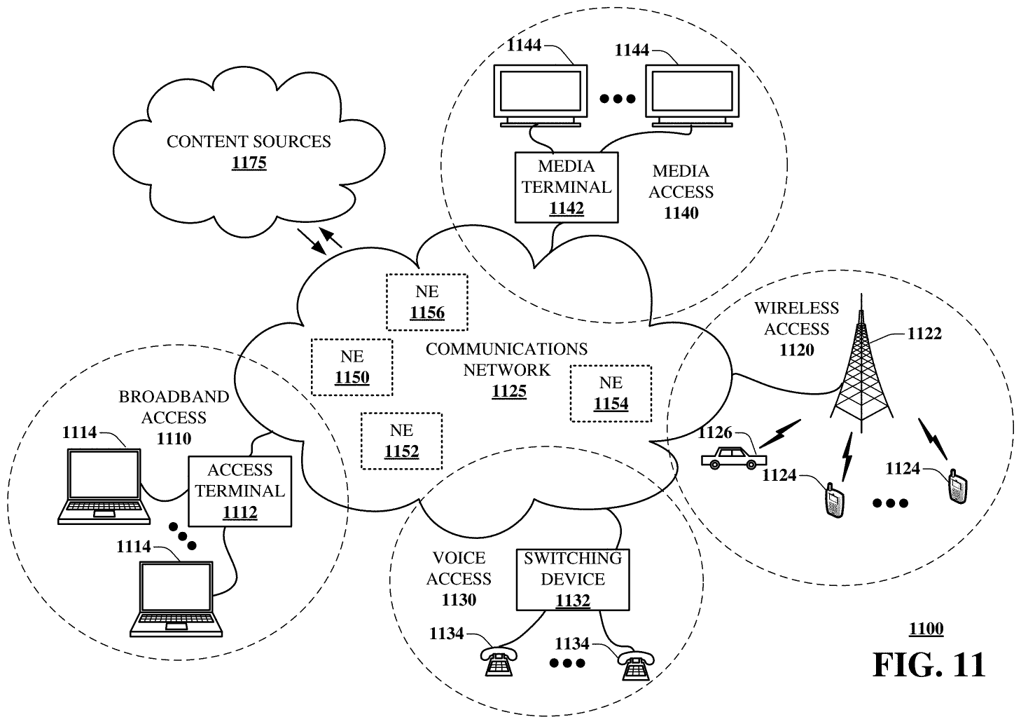

Referring now to FIG. 11, a block diagram is shown illustrating an example, non-limiting embodiment of a communications network 1100 in accordance with various aspects described herein. For example, communications network 1100 can facilitate in whole or in part capturing heterogeneous event data associated with a pool of customers, selecting, based on the heterogenous event data, a set of event labels and a set of customer labels, constructing, for each of a plurality of customers among the pool of customers, a respective time-ordered event sequence array comprising one or more event information items, applying a heterogenous event sequence model to generate, based on the respective time-ordered event sequences of the plurality of customers, an ordered series of event pathways, a topic set comprising a plurality of topics representing customer traits, and a respective topic weight set for each of the plurality of customers. In particular, a communications network 1125 is presented for providing broadband access 1110 to a plurality of data terminals 1114 via access terminal 1112, wireless access 1120 to a plurality of mobile devices 1124 and vehicle 1126 via base station or access point 1122, voice access 1130 to a plurality of telephony devices 1134, via switching device 1132 and/or media access 1140 to a plurality of audio/video display devices 1144 via media terminal 1142. In addition, communication network 1125 is coupled to one or more content sources 1175 of audio, video, graphics, text and/or other media. While broadband access 1110, wireless access 1120, voice access 1130 and media access 1140 are shown separately, one or more of these forms of access can be combined to provide multiple access services to a single client device (e.g., mobile devices 1124 can receive media content via media terminal 1142, data terminal 1114 can be provided voice access via switching device 1132, and so on).

The communications network 1125 includes a plurality of network elements (NE) 1150, 1152, 1154, 1156, etc. for facilitating the broadband access 1110, wireless access 1120, voice access 1130, media access 1140 and/or the distribution of content from content sources 1175. The communications network 1125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 1112 can include a digital subscriber line access multiplexer (DSLAM), cable modem termination system (CMTS), optical line terminal (OLT) and/or other access terminal. The data terminals 1114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 1122 can include a 4G, 5G, or higher generation base station, an access point that operates via an 802.11 standard such as 802.11n, 802.11ac or other wireless access terminal. The mobile devices 1124 can include mobile phones, e-readers, tablets, phablets, wireless modems, and/or other mobile computing devices.

In various embodiments, the switching device 1132 can include a private branch exchange or central office switch, a media services gateway, VoIP gateway or other gateway device and/or other switching device. The telephony devices 1134 can include traditional telephones (with or without a terminal adapter), VoIP telephones and/or other telephony devices.

In various embodiments, the media terminal 1142 can include a cable head-end or other TV head-end, a satellite receiver, gateway or other media terminal 1142. The display devices 1144 can include televisions with or without a set top box, personal computers and/or other display devices.

In various embodiments, the content sources 1175 include broadcast television and radio sources, video on demand platforms and streaming video and audio services platforms, one or more content data networks, data servers, web servers and other content servers, and/or other sources of media.

In various embodiments, the communications network 1125 can include wired, optical and/or wireless links and the network elements 1150, 1152, 1154, 1156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

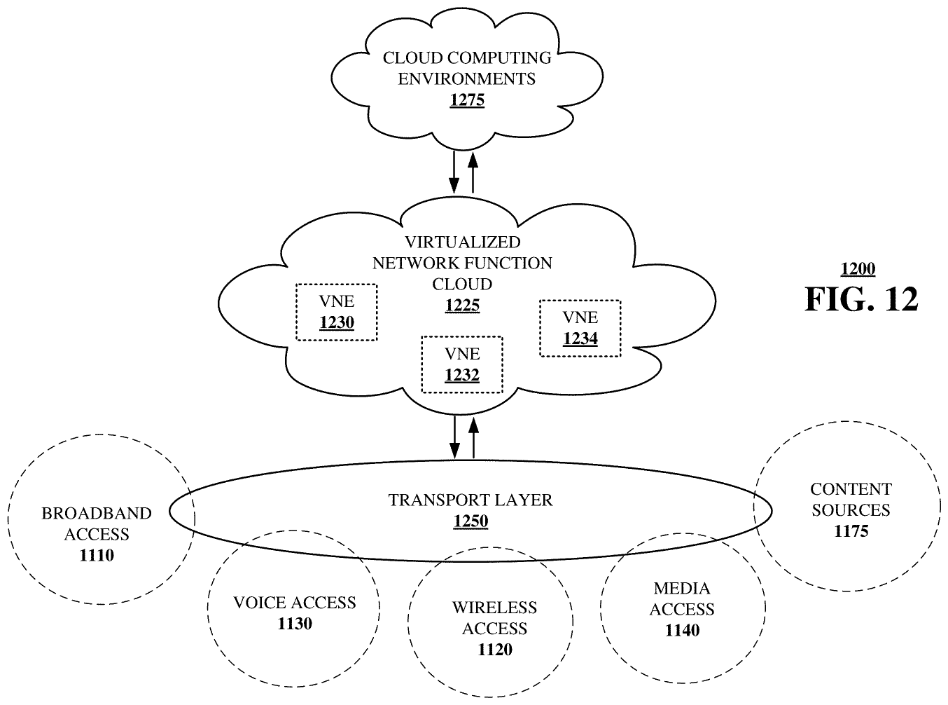

Referring now to FIG. 12, a block diagram 1200 is shown illustrating an example, non-limiting embodiment of a virtualized communication network in accordance with various aspects described herein. In particular a virtualized communication network is presented that can be used to implement some or all of the subsystems and functions of communication network 1100 and/or operations of methods 800, 900, and 1000 as presented in FIGS. 8-11. For example, virtualized communication network 1200 can facilitate in whole or in part capturing heterogeneous event data associated with a pool of customers, selecting, based on the heterogenous event data, a set of event labels and a set of customer labels, constructing, for each of a plurality of customers among the pool of customers, a respective time-ordered event sequence array comprising one or more event information items, applying a heterogenous event sequence model to generate, based on the respective time-ordered event sequences of the plurality of customers, an ordered series of event pathways, a topic set comprising a plurality of topics representing customer traits, and a respective topic weight set for each of the plurality of customers.

In particular, a cloud networking architecture is shown that leverages cloud technologies and supports rapid innovation and scalability via a transport layer 1250, a virtualized network function cloud 1225 and/or one or more cloud computing environments 1275. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 1230, 1232, 1234, etc. that perform some or all of the functions of network elements 1150, 1152, 1154, 1156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 1150 (shown in FIG. 11), such as an edge router can be implemented via a VNE 1230 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 1250 includes fiber, cable, wired and/or wireless transport elements, network elements and interfaces to provide broadband access 1110, wireless access 1120, voice access 1130, media access 1140 and/or access to content sources 1175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 1230, 1232 or 1234. These network elements can be included in transport layer 1250.

The virtualized network function cloud 1225 interfaces with the transport layer 1250 to provide the VNEs 1230, 1232, 1234, etc. to provide specific NFVs. In particular, the virtualized network function cloud 1225 leverages cloud operations, applications, and architectures to support networking workloads. The virtualized network elements 1230, 1232 and 1234 can employ network function software that provides either a one-for-one mapping of traditional network element function or alternately some combination of network functions designed for cloud computing. For example, VNEs 1230, 1232 and 1234 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 1230, 1232, 1234, etc. can be instantiated and managed using an orchestration approach similar to those used in cloud compute services.

The cloud computing environments 1275 can interface with the virtualized network function cloud 1225 via APIs that expose functional capabilities of the VNEs 1230, 1232, 1234, etc. to provide the flexible and expanded capabilities to the virtualized network function cloud 1225. In particular, network workloads may have applications distributed across the virtualized network function cloud 1225 and cloud computing environment 1275 and in the commercial cloud, or might simply orchestrate workloads supported entirely in NFV infrastructure from these third party locations.

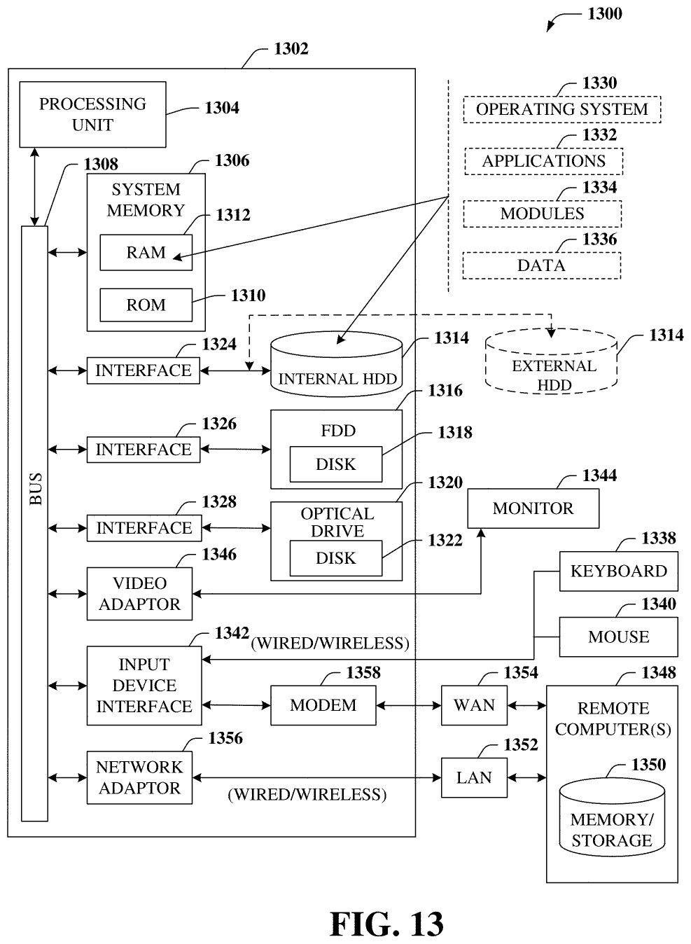

Turning now to FIG. 13, there is illustrated a block diagram of a computing environment in accordance with various aspects described herein. In order to provide additional context for various embodiments of the embodiments described herein, FIG. 13 and the following discussion are intended to provide a brief, general description of a suitable computing environment 1300 in which the various embodiments of the subject disclosure can be implemented. In particular, computing environment 1300 can be used in the implementation of network elements 1150, 1152, 1154, 1156, access terminal 1112, base station or access point 1122, switching device 1132, media terminal 1142, and/or VNEs 1230, 1232, 1234, etc. Each of these devices can be implemented via computer-executable instructions that can run on one or more computers, and/or in combination with other program modules and/or as a combination of hardware and software. For example, computing environment 1300 can facilitate in whole or in part capturing heterogeneous event data associated with a pool of customers, selecting, based on the heterogenous event data, a set of event labels and a set of customer labels, constructing, for each of a plurality of customers among the pool of customers, a respective time-ordered event sequence array comprising one or more event information items, applying a heterogenous event sequence model to generate, based on the respective time-ordered event sequences of the plurality of customers, an ordered series of event pathways, a topic set comprising a plurality of topics representing customer traits, and a respective topic weight set for each of the plurality of customers.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 13, the example environment can comprise a computer 1302, the computer 1302 comprising a processing unit 1304, a system memory 1306 and a system bus 1308. The system bus 1308 couples system components including, but not limited to, the system memory 1306 to the processing unit 1304. The processing unit 1304 can be any of various commercially available processors. Dual microprocessors and other multiprocessor architectures can also be employed as the processing unit 1304.

The system bus 1308 can be any of several types of bus structure that can further interconnect to a memory bus (with or without a memory controller), a peripheral bus, and a local bus using any of a variety of commercially available bus architectures. The system memory 1306 comprises ROM 1310 and RAM 1312. A basic input/output system (BIOS) can be stored in a non-volatile memory such as ROM, erasable programmable read only memory (EPROM), EEPROM, which BIOS contains the basic routines that help to transfer information between elements within the computer 1302, such as during startup. The RAM 1312 can also comprise a high-speed RAM such as static RAM for caching data.

The computer 1302 further comprises an internal hard disk drive (HDD) 1314 (e.g., EIDE, SATA), which internal HDD 1314 can also be configured for external use in a suitable chassis (not shown), a magnetic floppy disk drive (FDD) 1316, (e.g., to read from or write to a removable diskette 1318) and an optical disk drive 1320, (e.g., reading a CD-ROM disk 1322 or, to read from or write to other high capacity optical media such as the DVD). The HDD 1314, magnetic FDD 1316 and optical disk drive 1320 can be connected to the system bus 1308 by a hard disk drive interface 1324, a magnetic disk drive interface 1326 and an optical drive interface 1328, respectively. The hard disk drive interface 1324 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1302, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 1312, comprising an operating system 1330, one or more application programs 1332, other program modules 1334 and program data 1336. All or portions of the operating system, applications, modules, and/or data can also be cached in the RAM 1312. The systems and methods described herein can be implemented utilizing various commercially available operating systems or combinations of operating systems.

A user can enter commands and information into the computer 1302 through one or more wired/wireless input devices, e.g., a keyboard 1338 and a pointing device, such as a mouse 1340. Other input devices (not shown) can comprise a microphone, an infrared (IR) remote control, a joystick, a game pad, a stylus pen, touch screen or the like. These and other input devices are often connected to the processing unit 1304 through an input device interface 1342 that can be coupled to the system bus 1308, but can be connected by other interfaces, such as a parallel port, an IEEE 1394 serial port, a game port, a universal serial bus (USB) port, an IR interface, etc.

A monitor 1344 or other type of display device can be also connected to the system bus 1308 via an interface, such as a video adapter 1346. It will also be appreciated that in alternative embodiments, a monitor 1344 can also be any display device (e.g., another computer having a display, a smart phone, a tablet computer, etc.) for receiving display information associated with computer 1302 via any communication means, including via the Internet and cloud-based networks. In addition to the monitor 1344, a computer typically comprises other peripheral output devices (not shown), such as speakers, printers, etc.

The computer 1302 can operate in a networked environment using logical connections via wired and/or wireless communications to one or more remote computers, such as a remote computer(s) 1348. The remote computer(s) 1348 can be a workstation, a server computer, a router, a personal computer, portable computer, microprocessor-based entertainment appliance, a peer device or other common network node, and typically comprises many or all of the elements described relative to the computer 1302, although, for purposes of brevity, only a remote memory/storage device 1350 is illustrated. The logical connections depicted comprise wired/wireless connectivity to a local area network (LAN) 1352 and/or larger networks, e.g., a wide area network (WAN) 1354. Such LAN and WAN networking environments are commonplace in offices and companies, and facilitate enterprise-wide computer networks, such as intranets, all of which can connect to a global communications network, e.g., the Internet.

When used in a LAN networking environment, the computer 1302 can be connected to the LAN 1352 through a wired and/or wireless communication network interface or adapter 1356. The adapter 1356 can facilitate wired or wireless communication to the LAN 1352, which can also comprise a wireless AP disposed thereon for communicating with the adapter 1356.

When used in a WAN networking environment, the computer 1302 can comprise a modem 1358 or can be connected to a communications server on the WAN 1354 or has other means for establishing communications over the WAN 1354, such as by way of the Internet. The modem 1358, which can be internal or external and a wired or wireless device, can be connected to the system bus 1308 via the input device interface 1342. In a networked environment, program modules depicted relative to the computer 1302 or portions thereof, can be stored in the remote memory/storage device 1350. It will be appreciated that the network connections shown are example and other means of establishing a communications link between the computers can be used.

The computer 1302 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

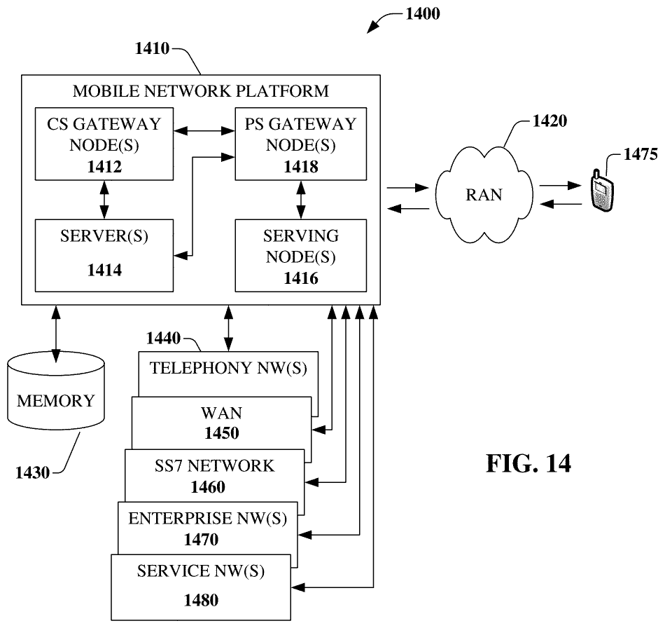

Turning now to FIG. 14, an embodiment 1400 of a mobile network platform 1410 is shown that is an example of network elements 1150, 1152, 1154, 1156, and/or VNEs 1230, 1232, 1234, etc. For example, platform 1410 can facilitate in whole or in part capturing heterogeneous event data associated with a pool of customers, selecting, based on the heterogenous event data, a set of event labels and a set of customer labels, constructing, for each of a plurality of customers among the pool of customers, a respective time-ordered event sequence array comprising one or more event information items, applying a heterogenous event sequence model to generate, based on the respective time-ordered event sequences of the plurality of customers, an ordered series of event pathways, a topic set comprising a plurality of topics representing customer traits, and a respective topic weight set for each of the plurality of customers. In one or more embodiments, the mobile network platform 1410 can generate and receive signals transmitted and received by base stations or access points such as base station or access point 1122. Generally, mobile network platform 1410 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 1410 can be included in telecommunications carrier networks, and can be considered carrier-side components as discussed elsewhere herein. Mobile network platform 1410 comprises CS gateway node(s) 1412 which can interface CS traffic received from legacy networks like telephony network(s) 1440 (e.g., public switched telephone network (PSTN), or public land mobile network (PLMN)) or a signaling system #7 (SS7) network 1460. CS gateway node(s) 1412 can authorize and authenticate traffic (e.g., voice) arising from such networks. Additionally, CS gateway node(s) 1412 can access mobility, or roaming, data generated through SS7 network 1460; for instance, mobility data stored in a visited location register (VLR), which can reside in memory 1430. Moreover, CS gateway node(s) 1412 interfaces CS-based traffic and signaling and PS gateway node(s) 1418. As an example, in a 3GPP UMTS network, CS gateway node(s) 1412 can be realized at least in part in gateway GPRS support node(s) (GGSN). It should be appreciated that functionality and specific operation of CS gateway node(s) 1412, PS gateway node(s) 1418, and serving node(s) 1416, is provided and dictated by radio technology(ies) utilized by mobile network platform 1410 for telecommunication over a radio access network 1420 with other devices, such as a radiotelephone 1475.

In addition to receiving and processing CS-switched traffic and signaling, PS gateway node(s) 1418 can authorize and authenticate PS-based data sessions with served mobile devices. Data sessions can comprise traffic, or content(s), exchanged with networks external to the mobile network platform 1410, like wide area network(s) (WANs) 1450, enterprise network(s) 1470, and service network(s) 1480, which can be embodied in local area network(s) (LANs), can also be interfaced with mobile network platform 1410 through PS gateway node(s) 1418. It is to be noted that WANs 1450 and enterprise network(s) 1470 can embody, at least in part, a service network(s) like IP multimedia subsystem (IMS). Based on radio technology layer(s) available in technology resource(s) or radio access network 1420, PS gateway node(s) 1418 can generate packet data protocol contexts when a data session is established; other data structures that facilitate routing of packetized data also can be generated. To that end, in an aspect, PS gateway node(s) 1418 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 1400, mobile network platform 1410 also comprises serving node(s) 1416 that, based upon available radio technology layer(s) within technology resource(s) in the radio access network 1420, convey the various packetized flows of data streams received through PS gateway node(s) 1418. It is to be noted that for technology resource(s) that rely primarily on CS communication, server node(s) can deliver traffic without reliance on PS gateway node(s) 1418; for example, server node(s) can embody at least in part a mobile switching center. As an example, in a 3GPP UMTS network, serving node(s) 1416 can be embodied in serving GPRS support node(s) (SGSN).

For radio technologies that exploit packetized communication, server(s) 1414 in mobile network platform 1410 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 1410. Data streams (e.g., content(s) that are part of a voice call or data session) can be conveyed to PS gateway node(s) 1418 for authorization/authentication and initiation of a data session, and to serving node(s) 1416 for communication thereafter. In addition to application server, server(s) 1414 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 1410 to ensure network's operation and data integrity in addition to authorization and authentication procedures that CS gateway node(s) 1412 and PS gateway node(s) 1418 can enact. Moreover, provisioning server(s) can provision services from external network(s) like networks operated by a disparate service provider; for instance, WAN 1450 or Global Positioning System (GPS) network(s) (not shown). Provisioning server(s) can also provision coverage through networks associated to mobile network platform 1410 (e.g., deployed and operated by the same service provider), such as the distributed antennas networks shown in FIG. 11(s) that enhance wireless service coverage by providing more network coverage.

It is to be noted that server(s) 1414 can comprise one or more processors configured to confer at least in part the functionality of mobile network platform 1410. To that end, the one or more processor can execute code instructions stored in memory 1430, for example. It is should be appreciated that server(s) 1414 can comprise a content manager, which operates in substantially the same manner as described hereinbefore.

In example embodiment 1400, memory 1430 can store information related to operation of mobile network platform 1410. Other operational information can comprise provisioning information of mobile devices served through mobile network platform 1410, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1430 can also store information from at least one of telephony network(s) 1440, WAN 1450, SS7 network 1460, or enterprise network(s) 1470. In an aspect, memory 1430 can be, for example, accessed as part of a data store component or as a remotely connected memory store.

In order to provide a context for the various aspects of the disclosed subject matter, FIG. 14, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

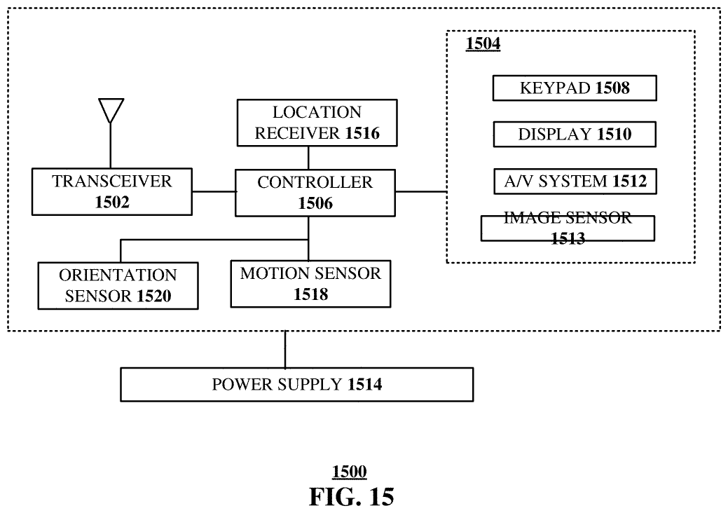

Turning now to FIG. 15, an illustrative embodiment of a communication device 1500 is shown. The communication device 1500 can serve as an illustrative embodiment of devices such as data terminals 1114, mobile devices 1124, vehicle 1126, display devices 1144 or other client devices for communication via either communications network 1125. For example, computing device 1500 can facilitate in whole or in part capturing heterogeneous event data associated with a pool of customers, selecting, based on the heterogenous event data, a set of event labels and a set of customer labels, constructing, for each of a plurality of customers among the pool of customers, a respective time-ordered event sequence array comprising one or more event information items, applying a heterogenous event sequence model to generate, based on the respective time-ordered event sequences of the plurality of customers, an ordered series of event pathways, a topic set comprising a plurality of topics representing customer traits, and a respective topic weight set for each of the plurality of customers.

The communication device 1500 can comprise a wireline and/or wireless transceiver 1502 (herein transceiver 1502), a user interface (UI) 1504, a power supply 1514, a location receiver 1516, a motion sensor 1518, an orientation sensor 1520, and a controller 1506 for managing operations thereof. The transceiver 1502 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 1502 can also be adapted to support circuit-switched wireline access technologies (such as PSTN), packet-switched wireline access technologies (such as TCP/IP, VoIP, etc.), and combinations thereof.

The UI 1504 can include a depressible or touch-sensitive keypad 1508 with a navigation mechanism such as a roller ball, a joystick, a mouse, or a navigation disk for manipulating operations of the communication device 1500. The keypad 1508 can be an integral part of a housing assembly of the communication device 1500 or an independent device operably coupled thereto by a tethered wireline interface (such as a USB cable) or a wireless interface supporting for example Bluetooth®. The keypad 1508 can represent a numeric keypad commonly used by phones, and/or a QWERTY keypad with alphanumeric keys. The UI 1504 can further include a display 1510 such as monochrome or color LCD (Liquid Crystal Display), OLED (Organic Light Emitting Diode) or other suitable display technology for conveying images to an end user of the communication device 1500. In an embodiment where the display 1510 is touch-sensitive, a portion or all of the keypad 1508 can be presented by way of the display 1510 with navigation features.

The display 1510 can use touch screen technology to also serve as a user interface for detecting user input. As a touch screen display, the communication device 1500 can be adapted to present a user interface having graphical user interface (GUI) elements that can be selected by a user with a touch of a finger. The display 1510 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 1510 can be an integral part of the housing assembly of the communication device 1500 or an independent device communicatively coupled thereto by a tethered wireline interface (such as a cable) or a wireless interface.

The UI 1504 can also include an audio system 1512 that utilizes audio technology for conveying low volume audio (such as audio heard in proximity of a human ear) and high volume audio (such as speakerphone for hands free operation). The audio system 1512 can further include a microphone for receiving audible signals of an end user. The audio system 1512 can also be used for voice recognition applications. The UI 1504 can further include an image sensor 1513 such as a charged coupled device (CCD) camera for capturing still or moving images.

The power supply 1514 can utilize common power management technologies such as replaceable and rechargeable batteries, supply regulation technologies, and/or charging system technologies for supplying energy to the components of the communication device 1500 to facilitate long-range or short-range portable communications. Alternatively, or in combination, the charging system can utilize external power sources such as DC power supplied over a physical interface such as a USB port or other suitable tethering technologies.

The location receiver 1516 can utilize location technology such as a global positioning system (GPS) receiver capable of assisted GPS for identifying a location of the communication device 1500 based on signals generated by a constellation of GPS satellites, which can be used for facilitating location services such as navigation. The motion sensor 1518 can utilize motion sensing technology such as an accelerometer, a gyroscope, or other suitable motion sensing technology to detect motion of the communication device 1500 in three-dimensional space. The orientation sensor 1520 can utilize orientation sensing technology such as a magnetometer to detect the orientation of the communication device 1500 (north, south, west, and east, as well as combined orientations in degrees, minutes, or other suitable orientation metrics).

The communication device 1500 can use the transceiver 1502 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 1506 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 1500.

Other components not shown in FIG. 15 can be used in one or more embodiments of the subject disclosure. For instance, the communication device 1500 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
capturing heterogeneous event data associated with a pool of customers;
selecting, based on the heterogenous event data, a set of event labels and a set of customer labels;
for each of a plurality of customers among the pool of customers, constructing a respective time-ordered event sequence array comprising one or more event information items;
applying a heterogenous event sequence model to the heterogeneous event data to generate, based on the respective time-ordered event sequence arrays of the plurality of customers:
an ordered series of event pathways;
a topic set comprising a plurality of topics representing customer traits; and
for each of the plurality of customers, a respective topic weight set comprising a corresponding weight for each of the plurality of topics of the topic set; and
initiating a customer care action for a customer among the plurality of customers, based on the respective topic weight set for the customer.

2. The device of claim 1, wherein the operations further comprise updating the heterogenous event sequence model based on received subject matter expert feedback.

3. The device of claim 2, wherein the operations further comprise:
generating model state information for presentation via a visual interface; and
receiving the subject matter expert feedback responsive to a presentation of the model state information via the visual interface.

4. The device of claim 1, wherein each event information item comprises an event label and a customer label.

5. The device of claim 1, wherein the plurality of customers comprise multi-service customers that are each provided with multiple services of a service provider.

6. The device of claim 1, wherein the ordered series of event pathways is ordered in order of importance.

7. The device of claim 1, wherein the set of event labels includes one or more event labels associated with account creation activities.

8. The device of claim 1, wherein the set of event labels includes one or more event labels associated with bill payment activities.

9. The device of claim 1, wherein the set of event labels includes one or more event labels associated with installation activities.

10. The device of claim 1, wherein the set of event labels includes one or more event labels associated with media content consumption activities.

11. A machine-readable medium, comprising executable instructions that, when executed by a processing system including a processor, facilitate performance of operations, the operations comprising:
capturing heterogeneous event data associated with a pool of customers;
selecting, based on the heterogenous event data, a set of event labels and a set of customer labels;
for each of a plurality of customers among the pool of customers, constructing a respective time-ordered event sequence array comprising one or more event information items;
applying a heterogenous event sequence model to the heterogeneous event data to generate, based on the respective time-ordered event sequence arrays of the plurality of customers:
a topic set comprising a plurality of topics representing customer traits; and
for each of the plurality of customers, a respective topic weight set comprising a corresponding weight for each of the plurality of topics of the topic set;
initiating a customer care action for a customer among the plurality of customers, based on the respective topic weight set for the customer;
generating model state information for presentation via a visual interface;
receiving subject matter expert feedback responsive to a presentation of the model state information via the visual interface; and
updating the heterogenous event sequence model based on the received subject matter expert feedback.

12. The machine-readable medium of claim 11, wherein each event information item comprises an event label and a customer label.

13. The machine-readable medium of claim 11, wherein the plurality of customers comprise multi-service customers that are each provided with multiple services of a service provider.

14. The machine-readable medium of claim 11, wherein the operations further comprise applying the heterogenous event sequence model to generate an ordered series of event pathways.

15. The machine-readable medium of claim 14, wherein the ordered series of event pathways is ordered in order of importance.

16. A method, comprising:
capturing, by a processing system including a processor, heterogeneous event data associated with a pool of customers;
selecting, by the processing system, based on the heterogenous event data, a set of event labels and a set of customer labels;
for each of a plurality of customers among the pool of customers, constructing, by the processing system, a respective time-ordered event sequence array comprising one or more event information items;
applying, by the processing system, a heterogenous event sequence model to the heterogeneous event data to generate, based on the respective time-ordered event sequence arrays of the plurality of customers:
an ordered series of event pathways;
a topic set comprising a plurality of topics representing customer traits; and
for each of the plurality of customers, a respective topic weight set comprising a corresponding weight for each of the plurality of topics of the topic set;
initiating a customer care action for a customer among the plurality of customers, based on the respective topic weight set for the customer;
generating, by the processing system, model state information for presentation via a visual interface;
receiving, by the processing system, subject matter expert feedback responsive to a presentation of the model state information via the visual interface; and
updating, by the processing system, the heterogenous event sequence model based on the received subject matter expert feedback.

17. The method of claim 16, wherein the set of event labels includes one or more event labels associated with account creation activities.

18. The method of claim 16, wherein the set of event labels includes one or more event labels associated with bill payment activities.

19. The method of claim 16, wherein the set of event labels includes one or more event labels associated with installation activities.

20. The method of claim 16, wherein the set of event labels includes one or more event labels associated with media content consumption activities.
